(19) United States
(12) Patent Application Publication
(10) Pub. No.: US 2024/0186804 A1
(43) Pub. Date: Jun. 6, 2024

(54) CHARGING DEVICE AND METHOD FOR CHARGING AT LEAST ONE ELECTRIC VEHICLE

(71) Applicant: Prettl Electronics Automotive GmbH, Radeberg (DE)

(72) Inventors: Udo HELLER, Radeberg (DE); Ulrich LIEDER, Radeberg (DE); Jan SCHMIDT, Radeberg (DE)

(21) Appl. No.: 18/441,829

(22) Filed: Feb. 14, 2024

Related U.S. Application Data
(63) Continuation of application No. PCT/EP2022/070550, filed on Jul. 21, 2022.

(30) Foreign Application Priority Data
Aug. 16, 2021 (DE) 10 2021 121 261.8

(51) Int. Cl. H02J 7/00; B60L 53/10; B60L 53/16; B60L 53/62; B60L 53/66

(52) U.S. Cl. CPC H02J 7/0029; B60L 53/11; B60L 53/16; B60L 53/62; B60L 53/66; H02J 7/0013

(57) ABSTRACT

A charging device for charging at least one electric vehicle that includes a plurality of electrical power units that provide electrical power for charging the electric vehicle. At least one charging port connects the charging device to the electric vehicle. And a coupling arrangement with switching elements can be activated in order to selectively connect the charging port to at least one power unit in such a way that electrical power can be transmitted from the at least one power unit to the charging port for charging the electric vehicle. The charging device also includes a controller for activating the switching elements, which is set up to prevent activation for switching over the individual switching elements while at least a predefined minimum current is flowing through the corresponding switching elements.

### CROSS-REFERENCE TO RELATED APPLICATIONS

This application is a continuation of international patent application PCT/EP2022/070550, filed on Jul. 21, 2022, which designating the U.S., and which international patent application has been published in German language and claims priority to national German patent application 10 2021 121 261.8, filed on Aug. 16, 2021. The entire contents of these priority applications are incorporated herein by reference in their entirety.

### SUMMARY

The invention relates to a charging device for charging at least one electric vehicle, wherein the charging device has a plurality of electrical power units for providing electrical power for charging the electric vehicle; at least one charging port for connecting the charging device to the electric vehicle; and a coupling arrangement with switching elements, wherein the switching elements can be actuated in such a way as to selectively connect the charging port to at least one power unit in such a way that electrical power can be transmitted from the at least one power unit to the charging port for charging the electric vehicle.

A charging device is described in US 2013/0057209 A1.

When fast charging electric vehicles with direct current, a relatively high electrical power must be transmitted. This makes it necessary to design the switching elements accordingly, which leads to high costs for known charging devices. In addition, in view of the relatively high voltages and currents required for fast charging of electric vehicles, attention must be paid to the operational safety of the charging device.

The object is therefore to improve the charging device of the type mentioned above in such a way that the required operational safety can be realized in a cost-effective manner.

To solve this problem, a charging device for charging at least one electric vehicle is proposed, which has the following features: a plurality of electrical power units for providing electrical power for charging the electric vehicle; at least one charging port for connecting the charging device to the electric vehicle; and a coupling arrangement with switching elements which can be actuated in order to connect the charging port selectively to at least one power unit in such a way that electrical power can be transmitted from the at least one power unit to the charging port for charging the electric vehicle; the charging device having a controller for actuating the switching elements, which is set up to prevent actuation for switching over the individual switching elements while a minimum current is flowing through the corresponding switching elements. By preventing actuation of the switching elements at a current above the minimum current, cost-effective switching elements configured for a low switching current can be used. In particular, it is possible to use switching elements that are intended for switching alternating current, even though direct voltages are to be switched. In addition, this results in high operational reliability with low wear of the switching elements.

It may be provided that a current sensor is assigned to at least one power unit, which is set up to detect a current emitted by the power unit to the coupling arrangement and the controller is set up to prevent switching as a function of the current detected by the current sensor. The function of preventing the actuation of the switching elements can thus be realized simply by detecting the current through the individual switching elements by the current sensor without recourse to other control and/or regulation functions of the charging device. This means that the intrinsic safety of the charging device can be reliably guaranteed and easily verified.

The charging device can have a message transmission device that is configured to forward messages from the charging port to those power units that are connected to the charging port for transmitting the electrical power. In this way, information about the charging process can be effectively forwarded to the relevant power units. In addition, functions of the controller can be distributed to control units of individual components, such as the charging port, the power unit or components of the coupling arrangement of the charging device.

The messages can contain status messages of any type. Preferably, the message has a status message that indicates a required termination of the power transfer to the vehicle, whereby the power units are set up to terminate the power transfer upon receipt of such a status message. This further improves the intrinsic safety of the charging device.

In particular, standardized charging interfaces, such as the Combined Charging System (CCS), include a communication interface between the electric vehicle and the charging device. Accordingly, the charging port can be configured to forward the message received from the electric vehicle or to generate the message as a result of receiving a message from the vehicle. The generation of the message as a result of receiving a message from the vehicle can be a protocol translation. The message received from the vehicle can have an emergency stop message that is sent by the vehicle if an error occurs there that makes it necessary to abort the charging process.

It may be provided that the coupling arrangement is configured to disconnect a selectable power unit from all charging ports. The switching elements can therefore be controlled in such a way that a specific power unit is not connected to any charging port. A power unit can be disconnected in this way, for example, if a fault has been detected on this power unit. The charging device can then continue to operate without using this faulty power unit. This results in a high overall availability of the charging device.

Here, the controller can be configured to select the power unit to be disconnected on the basis of a command received from the control unit and to control the coupling arrangement to disconnect the selected power unit. This makes it possible to replace a specific power unit while the charging device is in operation.

The maximum permissible switching current of the switching elements should be at least as high as the minimum current. Preferably, the minimum current should be as low as possible. The minimum current can be so low that it can just be detected by the current sensor. The minimum current can be at least essentially zero.

The coupling arrangement can have a coupling matrix, whereby rows of the coupling matrix are each assigned to a power unit and columns of the coupling matrix are each assigned to a charging port.

In order to achieve a compact design of the charging device and to achieve good maintainability of the charging device, it may be provided that the coupling arrangement has at least one rack which is configured to accommodate a plurality of circuit carriers of the coupling arrangement, with switching elements of a row of the coupling matrix being arranged on one of these circuit carriers in each case. The switching elements and any other components that are assigned to a row of the coupling matrix are also referred to below as a switching assembly. The circuit carrier can be a printed circuit board, for example. The structure of the coupling arrangement as a rack frame with the circuit carriers is compact and cost-effective.

Furthermore, the coupling arrangement constructed in this way is easily scalable in terms of the number of charging ports by cascading the circuit carriers. For example, the coupling arrangement can have several rack frames that are assigned to different columns of the coupling matrix, whereby the circuit carriers each have a part of the circuit elements of this row of the coupling matrix.

Alternatively or in addition to this, it may be provided that the rack frame is configured to accommodate a plurality of circuit carriers on which one or more switching elements of the same row of the coupling matrix are arranged. In both cases, a single circuit assembly comprises several cascaded circuit carriers. The circuit carriers can be manufactured as standard components that can be used in any charging device regardless of the number of charging ports.

In order to enable individual circuit carriers to be replaced, in particular during operation of the charging device, it may be provided that at least one of the circuit carriers can be detachably connected to the rack frame via a plug connector.

As a further solution to the above-mentioned object, a method for operating a charging device for charging at least one electric vehicle is proposed, wherein the method comprises providing electrical power for charging the electric vehicle from a plurality of electrical power units; connecting the charging device to the electric vehicle via at least one charging port; controlling switching elements of a coupling arrangement of the charging device to selectively connect the charging port to at least one power unit such that electrical power is transmitted from the at least one power unit to the charging port for charging the electric vehicle; and preventing switching of the individual switching elements while a minimum current is flowing through the corresponding switching elements. With this method, the advantages described here in connection with the switching device can be realized. In particular, a charging device described herein can be operated according to the method.

### BRIEF DESCRIPTION OF THE DRAWINGS

Further features and advantages result from the embodiment examples described below with reference to individual figures. These show:

FIG. 1 shows a block diagram of a charging device for charging an electric vehicle;

FIG. 2 shows a schematic representation of a coupling arrangement of the loading device of FIG. 1;

FIG. 3 shows a circuit carrier of the coupling arrangement of FIG. 2;

FIG. 4 shows a flowchart of a method of operating the charger; and

FIGS. 5 to 7 show different switching states of individual switching elements of the coupling arrangement from FIG. 2.

### DETAILED DESCRIPTION

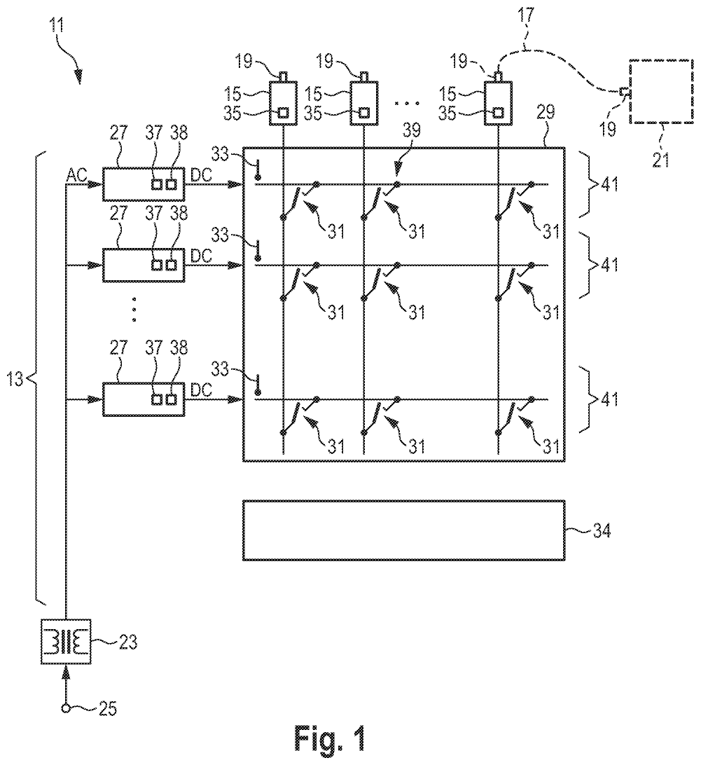

FIG. 1 shows a charging device 11 for charging several electric vehicles. The charging device 11 has a central power electronics unit 13 and several charging ports 15 connected to the central power electronics unit 13. As shown dashed in FIG. 1 for a charging port 15, the individual charging ports 15 can be electrically connected to an electric vehicle 21 by a charging cable 17, which has suitable charging connectors 19. The charging cable 17 and the charging connector 19 can be configured in accordance with a standard for charging electric vehicles, in particular for charging electric vehicles with direct current. For example, this may be the Combined Charging System (CCS). It is also possible for one end of the charging cable 17 to be permanently connected (i.e. without a connector) to the charging port 15. In this case, the charging connector 19 is only attached to one end of the charging cable 17 on the vehicle side.

Since the charging device 11 has several charging ports 15, it is particularly suitable for setting up charging parks for electric vehicles 21 where there are several parking spaces for these vehicles 21. In this case, the individual charging ports 15 are arranged at the individual parking spaces at a distance from the central power electronics 13. The central power electronics 13 can then be accommodated in a container or building, for example.

The charging device 11 also has a mains connection device 23, which is set up to connect the central power electronics 13 to an energy supply network 25. Since several vehicles 21 are to be charged quickly with relatively high power in the scenario described here, the power supply network 25 is a medium-voltage network. Accordingly, the grid connection device 23 has a medium-voltage transformer that converts the AC voltage (three-phase voltage or alternating voltage) taken from the medium-voltage grid 25 into a low voltage. A low-voltage main distribution (LVMD) is connected downstream of the medium-voltage transformer, which connects individual components of the central power electronics 13, in particular power units 27 of the central power electronics 13, to a secondary side of the medium-voltage transformer. In an embodiment example not shown, the grid connection device 23 has several medium-voltage transformers, whereby each power unit 27 is connected to the secondary side of precisely one of these medium-voltage transformers via the correspondingly configured LVMD. Deviating from the example shown, another grid connection device 23 can be provided, which is set up to connect the central power electronics 13 to a low-voltage grid and thus does not have a medium-voltage transformer.

The power units 27 are set up to convert the low voltage (e.g. 400 volts or 460 volts with three phases) supplied to them via the low-voltage main distribution board into a DC voltage. Particularly when using the CCS standard, the power units 27 are configured so that they can generate a DC voltage that can be set in the range from 200 volts to 1000 volts, for example. The individual power units 27 each have a fuse circuit 38 that can be activated to switch off the DC voltage DC at the output of the respective power unit 27. The fuse circuit 38 can be activated as a result of a fault within the respective power unit 27 or on receipt of a control message.

The individual power units 27 are connected to the individual charging ports 15 via a coupling arrangement 29 of the central power electronics 13. The coupling arrangement 29 has several electrically controllable switching elements 31. The switching elements 31 can be controlled in such a way that a specific charging port 15 is connected to a power unit 27 or several power units 27 selected during operation of the charging device 11 such that electrical power is transmitted from the corresponding power unit 27 or the corresponding power units 27 to the charging port 15 for charging the electric vehicle 21. It is therefore possible to optionally assign only a single power unit 27 to a charging port 15 or to assign several power units 27 to an individual charging port 15 by corresponding control of the switching elements 31, whereby their DC voltage outputs are then connected in parallel. The assignment of several power units 27 to a single charging port 15 can take place in cases where the electrical output power of a single power unit 27 is less than the electrical power required or desired for charging the vehicle 21.

The coupling arrangement 29 has current sensors 33, wherein a single current sensor 33 is associated with a particular power unit 27 and is arranged to detect a current fed back from or into that power unit 27. In the example shown, the number of current sensors 33 corresponds to the number of power units 27.

The charging device 11 has a controller which is set up to prevent the switching elements 31 from being activated for switching over the individual switching elements 31 while a minimum current is flowing through these switching elements. This current flowing through the switching elements 31 can be detected via the current sensors 33. In the example shown, the switching elements 31 are mechanical switches such as relays or contactors. When operating such switching elements 31, a maximum permissible switching current specified by the design of these switching elements 31 must be observed. If the switching element 31 is actuated while the current flowing through this switching element 31 exceeds the maximum permissible switching current, safe and low-wear switching is not guaranteed. Unwanted arcing can occur, particularly when switching direct currents. Preventing switching when the minimum current is reached or exceeded therefore represents a functionality for ensuring the inherent safety of the charging device 11, in particular the coupling arrangement 29. A suitable value can be selected for the minimum current that does not exceed the maximum permissible switching current. For example, a value can be selected that essentially corresponds to a current of zero or almost zero. For example, a minimum current can be selected that is so low that it can no longer be detected by the current sensors 33 used. By preventing the switching elements 31 from switching at a current that is at least as high as the minimum current, it is possible to use relatively compact and inexpensive switching elements 31 that are configured for a low switching current at a DC voltage to be switched. In particular, there is no need to use relatively expensive DC contactors, each of which has a device for extinguishing an arc caused by switching under current. The switching elements 31 can therefore be contactors or relays configured for switching alternating currents.

In the embodiment shown, the controller is distributed, i.e. in addition to a central control unit 34, the controller also includes other control units integrated into the coupling arrangement 29. Furthermore, the charging ports 15 can also have control units, which are to be referred to as charging point control units 35. Accordingly, the power units 27 may have power unit control units 37. The individual control units 34, 35, 37 of the control system are interconnected by suitable communication devices such as buses or communication networks (not shown in FIG. 1). The control units 34, 35, 37 can be implemented using a suitable combination of hardware and software. For example, the control units 34, 35, 37 can have a programmable computer, which can be part of a microcontroller. Individual functions of the control units 34, 35, 37 can also be realized by digital logic, such as FPGAs or ASICs. At least one computer program is provided which executes the functions described herein, in particular steps of the method described herein, when the program is made to run on a programmable computer of at least one of the controllers 34, 35, 37.

The coupling arrangement 29 can have a coupling matrix 39 or be formed by such a matrix. The coupling matrix 39 has several rows of conductors or rails, each of which is connected to the output of a power unit 27. Thus, the number of rows corresponds to the number of power units 27. Furthermore, conductors or rails arranged in columns are provided, each of which is connected to the DC voltage inputs of a charging port 15. Accordingly, the number of columns corresponds to the number of charging ports 15. The individual switching elements 31 are arranged at the intersections of the rows and columns. In order to illustrate the matrix topology of the coupling arrangement 29, the switching elements in FIG. 1 are shown as single-pole switches for the sake of simplicity. Since the coupling arrangement 29, in particular its coupling matrix 39, is set up to connect a DC voltage input of a charge port 15 to the DC voltage output of at least one power unit 27, the individual switching elements 31 are configured as two-pole switches. As described above, these can be relays or contactors, for example.

Rows and columns are used here only to denote the two dimensions of the overall two-dimensional matrix structure 39. In the same way, the conductors or rails connected to the inputs of the charging port 15 could be referred to as rows and the conductors or rails connected to the outputs of the individual power units 27 could be referred to as columns.

In the embodiment described here, the switching elements 31 belonging to the dimension of the matrix 39 designated as “row”, which are assigned to a specific power unit 27, are combined to form a switching assembly 41. Such a switching assembly 41 thus comprises the components of at least part of a row of the coupling matrix 39.

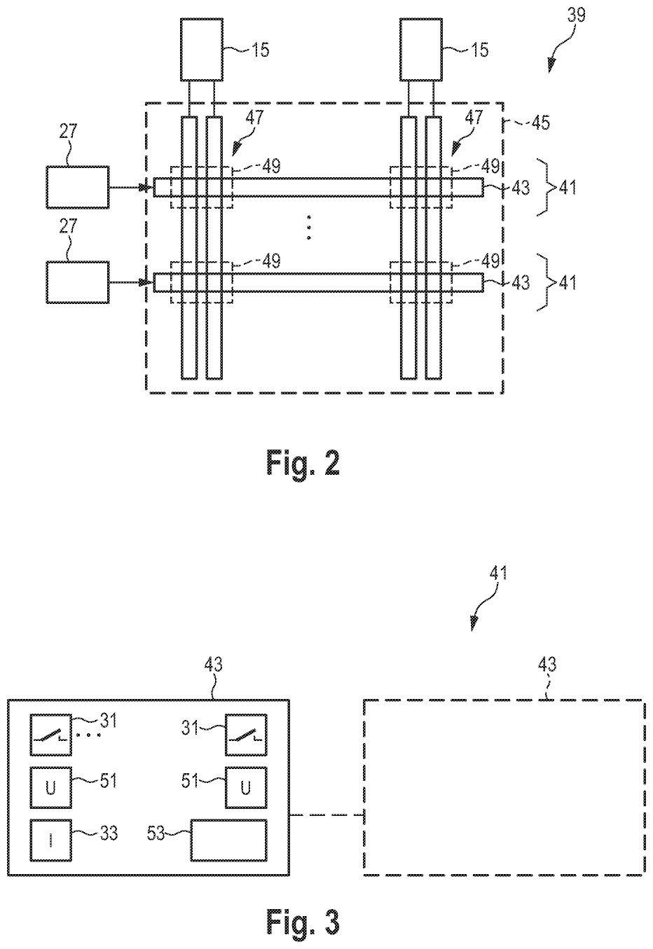

FIG. 2 shows the mechanical structure of the coupling matrix 39. Here, each switching module 41 has at least one circuit carrier 43 on which the components of at least part of a row of the coupling matrix 39 are arranged, these components being assigned to a specific power unit 27. The circuit carrier 43 may, for example, be a printed circuit board. The individual circuit carriers 43 are each connected to a power unit 27 assigned to them.

The individual circuit carriers 43 are arranged in a rack frame 45, also referred to as a “rack”. The rack frame 45 has several two-pole DC-lines 47 assigned to the individual columns of the coupling matrix 39. The switching module 41 or its circuit carrier 43 are detachably connected to the individual DC-lines 47 via plug connectors 49 in such a way that the individual switching modules 41 can be removed from the rack frame 45 of the switching matrix 39 and reinserted into it, in particular for maintenance purposes.

FIG. 3 shows a top view of a circuit carrier 43 shown in FIG. 2. The individual switching elements 31 assigned to a specific row of the coupling matrix 39 can be seen, two of which are shown for the sake of clarity. In addition to the current sensor 33 for detecting the current drawn from or fed back into the respective power unit, the switching assembly 41 also has voltage sensors 51. The voltage sensors are configured to measure the DC-voltage applied to the individual DC-lines 47. The voltage sensors 51 can be used to carry out a self-test of the individual switching elements 31 (so-called sticking test). Finally, the circuit carrier 43 has a switching module control unit 53, which is part of the distributed controller of the charging device. The switching module control unit 53 can have a programmable computer with program memory, which can form part of a microcontroller or can contain an FPGA.

As shown as a dashed line in FIG. 3, several circuit carriers 43 can be cascaded in order to provide for switching modules 41 that have a larger number of outputs (columns assigned to the individual charging ports 15) than can be sensibly arranged on one circuit carrier 43. A switching module 41 can therefore comprise several circuit carriers 41. Such larger switching assemblies 41 formed by cascading several circuit carriers 43 can, for example, be arranged in several rack frames 45, which are placed next to each other, for example. Alternatively, it can also be provided that a row of a single rack frame 45 is set up to accommodate several circuit carriers 43 that are assigned to different columns.

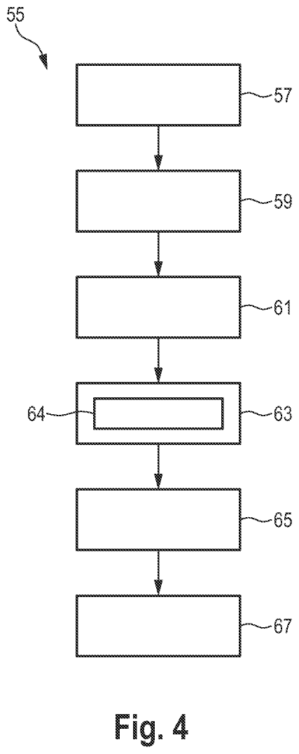

FIG. 4 shows a flow diagram of a method 45 for operating the charging device 11. After a start 57 of the method, a step 59 is carried out which comprises a self-test of the charging device 11. This self-test includes a so-called “sticking test” to check the functionality of the individual switching elements 31. In this sticking test, the controller, for example the switching module control unit 53, controls the switching elements 31 of a row of the coupling matrix after the controller has controlled the corresponding power unit 27 in such a way that a DC-voltage DC is applied to its output which is sufficiently high to be detected by the voltage sensors 51. During the sticking test, each switching element 31 of the corresponding line or switching assembly 41 is controlled in such a way that it is closed for a certain duration and opened for a certain duration. At the same time, it is checked whether the voltages on both sides of the individual switching elements 31 differ from each other when the respective switching elements 31 are open. For example, it can be checked whether the voltage detected by the respective voltage sensors 51 is at least substantially different from zero in the case of the respective closed switching element 31. If this is the case, the corresponding switching element 31 is considered to be functional. If this is not the case, a fault is detected in the respective switching element 31.

In addition, it is also possible to check whether the voltages on both sides of the individual switching elements 31 are at least essentially the same when the respective switching elements 31 are closed. Here, for example, it is possible to check whether the voltage detected by the respective voltage sensor 51 corresponds at least substantially to the set voltage at the output of the corresponding power unit 27. If this is the case, the corresponding switching element 31 is considered to be functional. Otherwise, a fault is detected in the respective switching element 31.

The fault can be logged and reported for the purpose of remote maintenance. It may be provided that the charging device 11 is put out of operation if an error is present.

In a step 61 following step 59, it is checked which power units 27 are to be assigned to a specific charging port 15. This check can be carried out depending on information transmitted via the charging cable 17 from the corresponding electric vehicle 21. This information may include a charging voltage required by the respective vehicle 21, a charging current desired by the vehicle 21 and/or a charging power requested by the vehicle 21. It may be the case that the desired charging current or the requested charging power is limited as a function of tariff information relating to a customer (user of the vehicle 21). Specifically, it may be determined in step 61 that a single power unit 27 is sufficient to provide a desired current or power for the respective vehicle 21. If it is determined that a single power unit 27 is sufficient, then exactly one power unit is identified which is to be assigned to the charging port 15. However, if the power or current of a single power unit 27 is not sufficient for charging a particular vehicle 21, then in step 61 a plurality of power units 27 are identified and assigned to a single charging port 15. It may be the case that—for example when planning the charging device 11—a maximum number of power units 27 to be connected to a single charging port 15 is specified and stored in the control arrangement. Step 61 then comprises limiting the number of power units 27 assigned to a single charging port 15 to the specified and stored maximum number.

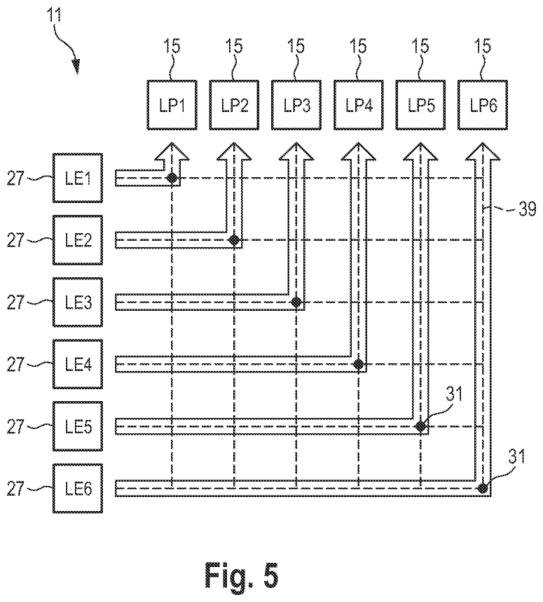

Subsequently, in a step 63, actuating commands for the individual switching elements 31 are determined on the basis of the result of step 61. The states (open or closed) of the switching elements 31 corresponding to these actuating commands are shown in FIGS. 5 to 7, with a dot representing a closed switching element 31. The controller controls the switching elements 31 in accordance with the actuating commands so that they are either open or closed. In a sub-step 64 of step 63, the controller detects the currents at the outputs of the power units 27 by the current sensors 33. Depending on the detected currents, the sub-step 64 prevents switching, i.e. actuation, of the individual switching elements 31 while or as long as a predetermined minimum current flows through the respective switching elements 31. For this purpose, each detected current can be compared with a threshold value that characterizes the minimum current. The threshold value can correspond to a low current. For example, the threshold value can be zero; the minimum current then corresponds to the smallest current that can still be detected by the current sensors 33. Alternatively, a higher minimum current or a threshold value can be selected, which corresponds to a current that does not exceed a permissible switching current of the switching elements 31. The step 63 and/or its sub-step 64 can be executed by the switching module control unit 53.

FIG. 5 shows an example of a charging device 11 whose coupling matrix 39 has six rows and six columns and thus six power units 27 and six charging ports 15 are present. In general, the number of rows of the coupling matrix 39 corresponds to the number of power units 27 of the charging device 11 and the number of columns of the coupling matrix 39 corresponds to the number of charging ports 15 of the charging device 11. The numbers of power units 15 and charging ports 27 can be chosen as desired. In particular, the number of power units does not have to correspond to the number of charging ports. The closed switching elements 31 are shown as points in the coupling matrix 39 shown schematically with dashed lines. In the scenario shown in FIG. 5, one electric vehicle 21, which requires a relatively low charging power, is connected to each charging port 15. Accordingly, only the switching elements 31 lying on a diagonal of the matrix 39 are closed, so that each charging port 15 is connected to exactly one power unit 27.

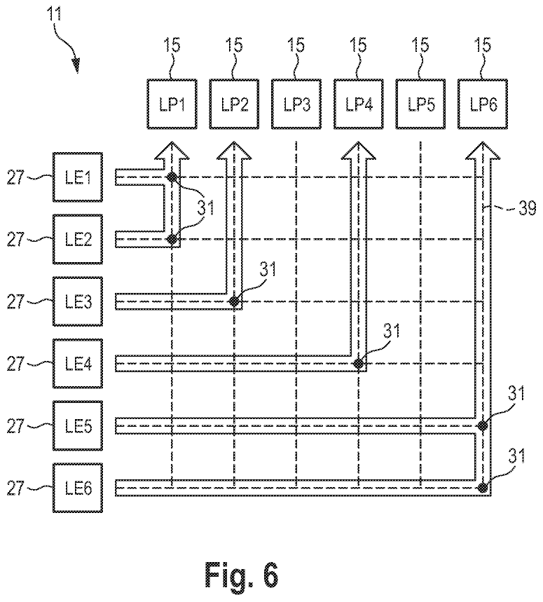

FIG. 6 illustrates a scenario in which a vehicle is connected to each of the charging ports 15, labeled LP1 and LP6, which requires a comparatively large amount of power for charging. Vehicles 21 that require a comparatively low charging power are connected to the charging ports LP2 and LP4. The charging ports LP3 and LP5 are free, i.e. not connected to a vehicle. In order to be able to supply a comparatively high electrical power to the vehicles connected to the charging ports LP1 and LP6, two switching elements 31 are closed in each of the corresponding columns. The charging port LP1 is thus connected to the two power units LE1 and LE2 and the charging port LP6 is connected to the two power units LE5 and LE6. Assuming that all power units 27 have the same power, this results in a doubled electrical power for the vehicles connected to the charging ports LP1 and LP6. In contrast, the vehicles connected to the charging ports LP2 and LP4 can only draw the single charging power that can be provided by a single power unit 27. Deviating from the scenario shown in FIG. 6, more than two switching elements 31 of a column of the coupling matrix 39 can also be closed simultaneously in order to connect more than two power units 27 to a single charging port 15, so that the vehicle 21 connected to this charging port 27 can be charged with an even higher current.

In a step 65, the charging device 11 performs charging operations to charge the batteries of the individual vehicles 21. Here, the individual power units 27 are set so that they supply the appropriate voltage for the respective vehicles 21, so that electrical power for charging the respective vehicle 21 is provided by the respective power units 27. Furthermore, the charging ports 15, controlled by their charging point control units 35, maintain a communication link in the respective vehicles 21 in order to monitor the status of the respective charging process. Here, the charge ports 15 can receive messages from the respective vehicle 21 and forward them within the controller. Such messages can, for example, include status messages generated by the vehicle 21, such as an emergency stop command. The controller can be programmed to cancel the charging process for a specific vehicle if such a status message is received. If the charging process is to be aborted, then the fuse circuit 38 of the affected power units 27 is activated (for example by a switchgear control unit 53 sending a control message to the affected power unit 27) to remove the DC-voltage from the outputs of these power units 27.

The method further comprises a step 67 for excluding individual power units 27 from the active operation of the charging device 11. Such exclusion enables, for example, maintenance work to be carried out on the corresponding power unit 27 or the corresponding switching assembly 41. The exclusion, also referred to as disconnection, may be triggered by an error message generated within the charging device 11 and/or a command received from the controller. For example, the command can be received via an operator terminal of the central control unit 34 or via a communication interface of the central control unit 34. On the basis of the error message or the command, the power unit 27 to be disconnected is identified and all switching elements 31 belonging to the row of the matrix 39 assigned to this power unit 27 are opened. All other power units 27 and all charging ports 15 can continue to be operated. Step 67 thus enables operation of the charging device 11 with one or more disconnected power units 27 or circuit assemblies 41.

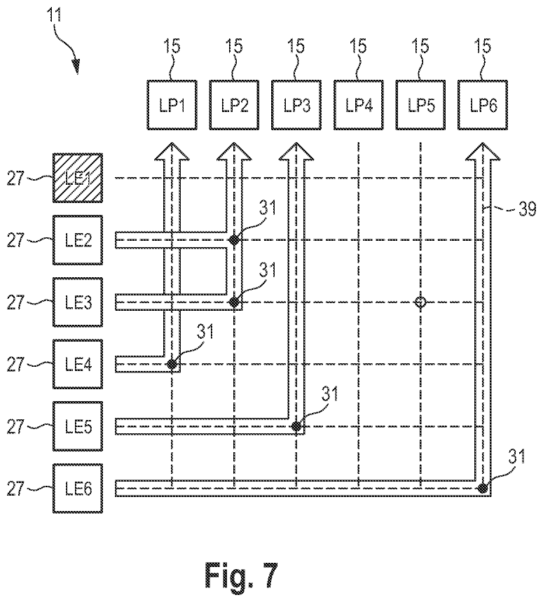

FIG. 7 shows an example where the hatched power unit LE1 is disconnected, i.e. excluded from the active operation of the charging device 11. The charging port LP1 is supplied by the power unit LE4. The power unit LE5 is connected to the charging port LP3 and the power unit LE6 is connected to the charging port LP6. A higher charging power was requested at charging port LP2. Therefore, the two power units LE2 and LE3 are connected to the charging port LP2, i.e. connected in parallel. If another vehicle 21 now additionally requests power at the charging port LP5, it can be provided that the provision of power at LP5 is delayed for a certain time and/or the parallel connection of the power units LE2 and LE3 is canceled so that, for example, the power unit LE3 can be connected to the charging port LE5.

The method 55 is executed regularly, for example periodically and/or after the occurrence of a predetermined event during operation of the charging device 11. Such a predetermined event may include the connection and/or disconnection of a vehicle to or from the charging device 11 by a user and/or the reaching of a certain charge level (e.g. partial or full charge) of the battery of a vehicle. By regularly executing the procedure, the coupling matrix can be reconfigured during ongoing charging operation, i.e. individual switching elements 31 can be switched over. In this way, a power unit 27 can be disconnected from a vehicle 21 and assigned to the other vehicle when a new charging request is received after another vehicle 21 has been connected to the charging device 11.

In summary, the charging device described here has a coupling arrangement 29 which can be realized at low cost and whose switching elements 31 can be configured for a very low switching current. In addition, operation of the charging device 11 is possible in the event of failure of a power unit 27 and/or the switching module 41. Individual power units 27 and/or switching assemblies 41 can be disconnected during operation of the charging device 11, so that replacement or maintenance of these components 27, 41 is possible without impairing the availability of the charging device 11. The voltage monitoring, in particular the adhesion test, and the disconnection of the power units 27 by activating the fuse circuit 38 in the event of a fault contribute to a high level of operational reliability of the charging device 11.

1. A charging device configured to charge at least one electric vehicle, comprising:
a plurality of electrical power units configured to provide electrical power for charging the electric vehicle;
at least one charging port that, via a charging cable, is configured to connect the charging device to the electric vehicle;
a coupling arrangement with switching elements which can be activated to selectively connect the charging port to at least one power unit of the plurality of power units in such a way that electrical power can be transmitted from the at least one power unit to the at least one charging port for charging of the electric vehicle; and
a controller configured to activate the switching elements, the controller configured to prevent activation for switching over individual switching elements while at least a predefined minimum current is flowing through the individual switching elements.

2. The device according to claim 1, wherein at least one power unit is assigned a current sensor which is set up to detect a current emitted by the power unit to the coupling arrangement and the controller is set up to prevent the switching over as a function of the current detected by the current sensor.

3. The device according to claim 1, wherein the charging device has a message transmission device which is configured to forward messages from the charging port to those power units which are connected to the charging port for transmitting the electrical power.

4. The device according to claim 3, wherein the message comprises a status message indicating a required termination of the power transmission to the vehicle, and the power units are configured to terminate the power transmission upon receipt of such a status message.

5. The device according to claim 3, wherein the charging port is configured to forward the message received from the electric vehicle or to generate the message as a result of receiving a message from the vehicle.

6. The device according to claim 1, wherein the coupling arrangement is configured for disconnecting a selectable power unit from all charging ports.

7. The device according to claim 6, wherein the controller is arranged to select the power unit to be disconnected at least on the basis of a command received from the controller and to control the coupling arrangement to disconnect the selected power unit.

8. The device according to claim 1, wherein a maximum permissible switching current of the switching elements is at least as large as the minimum current.

9. The device according to claim 1, wherein the coupling arrangement has a coupling matrix, wherein rows of the coupling matrix are each assigned to a power unit and columns of the coupling matrix are each assigned to a charging port.

10. The device according to claim 9, wherein the coupling arrangement has at least one rack frame which is configured to accommodate a plurality of circuit carriers of the coupling arrangement, wherein switching elements of a row of the coupling matrix are arranged on one of these circuit carriers in each case.

11. The device according to claim 10, wherein the coupling arrangement has a plurality of rack frames which are assigned to different columns of the coupling matrix, wherein the circuit carriers each comprise a part of the circuit elements of this row of the coupling matrix.

12. The device according to claim 10, wherein the rack frame is configured to accommodate a plurality of circuit carriers on which one or more switching elements of the same row of the coupling matrix are arranged.

13. The device according to claim 10, wherein at least one of the circuit carriers is detachably connectable to the rack frame via a plug connector.

14. A method of operating a charging device for charging at least one electric vehicle, the method comprising:
providing electrical power for charging the electric vehicle from a plurality of electrical power units;
connecting the charging device to the electric vehicle via at least one charging port;
controlling switching elements of a coupling arrangement of the charging device to selectively connect the charging port to at least one power unit such that electrical power is transmitted from the at least one power unit to the charging port for charging the electric vehicle; and
preventing the switching of individual switching elements while at least a predefined minimum current is flowing through the individual switching elements.

15. A charging device configured to charge an electric vehicle comprising:
a plurality of electrical power units configured to provide direct current electrical power for charging the electric vehicle;
at least one charging port that, via a charging cable, is configured to connect the charging device to the electric vehicle;
a coupling arrangement including alternating current switching elements which can be activated to selectively connect the charging port to at least one power unit of the plurality of power units so that electrical power can be transmitted from the at least one power unit to the at least one charging port to charge the electric vehicle; and
a controller configured to activate ones of the switching elements, the controller configured to prevent activation of specific switching elements, of the ones of the switching elements, that have at least predefined minimum current detected as flowing through them.
